(19) United States
(12) Patent Application Publication
(10) Pub. No.: US 2014/0193083 A1
(43) Pub. Date: Jul. 10, 2014

(54) METHOD AND APPARATUS FOR DETERMINING THE RELATIONSHIP OF AN IMAGE TO A SET OF IMAGES

(71) Applicant: NOKIA CORPORATION, Espoo (FI)

(72) Inventor: Bennett D. Marks, Carlisle, MA (US)

(73) Assignee: NOKIA CORPORATION, Espoo (FI)

(21) Appl. No.: 13/737,507

(22) Filed: Jan. 9, 2013

(51) Int. Cl. G06K 9/68

(52) U.S. Cl. CPC G06K 9/68
USPC 382/218

(57) ABSTRACT

A method, apparatus, and computer program product are disclosed to determine the relationship of an image to a set of images. In the context of a method, information about a set of images is received. The method also receives an image from the set of images. The method determines, by a processor, information about a relationship of the image to the set of images. The method also causes storage of the image in conjunction with metadata about the image. The metadata includes the information about the relationship of the image to the set of images. The method may also repeat the above operations until a determined number of images have been stored in conjunction with respective metadata, in which case the information about the relationship of the image to the set of images includes a parameter specifying the number of images in the set of images.

### TECHNOLOGICAL FIELD

Example embodiments of the present invention relate generally to digital image metadata, and more particularly, to a method and apparatus for determining the relationship of an image to a set of images.

### BACKGROUND

There are many situations where a photographer will decide to take multiple images with the intent of post-processing the images to generate a creative or technical result that would not be possible with only a single image. To achieve the creative or technical result, the photographer may, for example, vary a number of parameters while capturing images, such as the direction, exposure time, F-stop, and focal length. The photographer is then able to post-process the various images in conjunction by, for example, creating a “focus stack,” a High Dynamic Range (HDR) image, a panorama image, or by otherwise using different features from the multiple images to generate the intended creative or technical result.

Given the modern ubiquity of digital camera technology today, this post-processing is often performed using software that can read and edit digital images. Digital images, in turn, usually include descriptive metadata, such as, for example, data specifying the owner of an image and a time and/or date stamp identifying when the image was captured. Some of this metadata is written by the camera and some may be input later by the photographer. For instance, additional metadata can be added using the above-referenced post-processing software. Using such software to process a set of images as a “focus stack” or an “HDR image,” for example, requires the user to identify and pick out the set of images to be used and to then assign the process that is to be applied to those images.

### BRIEF SUMMARY

With the proliferation of services now available, this post-processing may require a user to perform a burdensome set of steps to produce the intended outcome. Accordingly, a method, apparatus, and computer program product are provided to facilitate the automatic capture of user intent with respect to a plurality of still images so as to reduce or eliminate manual identification of the relevant images and the manual assignment of the processes to be applied to those images. The method, apparatus, and computer program product of an example embodiment may automatically update the metadata of the various images, thereby removing the burden of manual data entry while efficiently capturing the user's intent.

In a first example embodiment, a method is provided that includes receiving information about a set of images, receiving an image from the set of images, determining, by a processor, information about a relationship of the image to the set of images, and causing storage of the image in conjunction with metadata about the image. The metadata includes the information about the relationship of the image to the set of images.

In one embodiment of the method, the information about the relationship of the image to the set of images may include a parameter specifying that the image is part of the set of images, and a parameter specifying a sequence number of the image within the set of images. In this embodiment, the information about the relationship of the image to the set of images may further include a parameter describing the set of images.

The method of another embodiment may determine a parameter specifying a post-processing action to be performed on the set of images, wherein the metadata includes the parameter specifying the post-processing action to be performed on the set of images. In another embodiment, the method may include determining at least one parameter describing a characteristic specific to the individual image, wherein the metadata includes the parameter specifying the characteristic specific to the individual image.

In another embodiment of the method, the information about the set of images may additionally include information about image variables that will change between images. In yet another embodiment, the method may further determine a number of image files to be associated with the set of images, wherein the operations of receiving an image, determining information about a relationship of the image to the set of images, and causing storage of the image are repeated until the determined number of images have been stored in conjunction with respective metadata. The information about the relationship of the image to the set of images may include a parameter specifying the number of images in the set of images.

In another example embodiment, an apparatus is provided that comprises at least one processor and at least one memory including computer program code with the at least one memory and the computer program code configured to, with the one processor, cause the apparatus to receive information about a set of images, receive an image from the set of images, determine information about a relationship of the image to the set of images, and cause the image to be stored in conjunction with metadata about the image. The metadata includes the information about the relationship of the image to the set of images.

In one embodiment of the apparatus, the information about the relationship of the image to the set of images may include a parameter specifying that the image is part of the set of images, and a parameter specifying a sequence number of the image within the set of images. In this embodiment, the information about the relationship of the image to the set of images may further include a parameter describing the set of images.

In another embodiment of the apparatus, the at least one memory and the computer program code are configured to cause the apparatus to determine a parameter specifying a post-processing action to be performed on the set of images, wherein the metadata includes the parameter specifying the post-processing action to be performed on the set of images. In another embodiment, the at least one memory and the computer program code are configured to cause the apparatus to determine at least one parameter describing a characteristic specific to the individual image, wherein the metadata includes the parameter specifying the characteristic specific to the individual image.

In another embodiment, the information about the set of images may additionally include information about image variables that will change between images. In yet another embodiment, the at least one memory and the computer program code are configured to cause the apparatus to determine a number of image files to be associated with the set of images, and repeat the operations of receiving an image, determining information about a relationship of the image to the set of images, and causing storage of the image until the determined number of images have been stored in conjunction with respective metadata. The information about the relationship of the image to the set of images may include a parameter specifying the number of images in the set of images.

In another example embodiment, a computer program product is provided that includes at least one non-transitory computer-readable storage medium having computer-executable program code portions stored therein with the computer-executable program code portions comprising program code instructions that, when executed, cause an apparatus to receive information about a set of images, receive an image from the set of images, determine information about a relationship of the image to the set of images, and cause the image to be stored in conjunction with metadata about the image. The metadata may include the information about the relationship of the image to the set of images.

In one embodiment of the computer program product, the information about the relationship of the image to the set of images may include a parameter specifying that the image is part of the set of images, and a parameter specifying a sequence number of the image within the set of images. In this embodiment, the information about the relationship of the image to the set of images may further include a parameter describing the set of images.

In another embodiment of the computer program product, the computer-executable program code portions comprise program code instructions that, when executed, cause an apparatus to determine a parameter specifying a post-processing action to be performed on the set of images, wherein the metadata includes the parameter specifying the post-processing action to be performed on the set of images. In another embodiment, the computer-executable program code portions comprise program code instructions that, when executed, cause an apparatus to determine at least one parameter describing a characteristic specific to the individual image, wherein the metadata includes the parameter specifying the characteristic specific to the individual image.

In another embodiment, the information about the set of images may additionally include information about image variables that will change between images. In yet another embodiment, the computer-executable program code portions comprise program code instructions that, when executed, cause an apparatus to determine a number of image files to be associated with the set of images, and repeat the operations of receiving an image, determining information about a relationship of the image to the set of images, and causing storage of the image until the determined number of images have been stored in conjunction with respective metadata. The information about the relationship of the image to the set of images may include a parameter specifying the number of images in the set of images.

In another example embodiment, an apparatus is provided that includes means for receiving information about a set of images, means for receiving an image from the set of images, means for determining information about a relationship of the image to the set of images, and means for causing storage of the image in conjunction with metadata about the image. The metadata includes the information about the relationship of the image to the set of images.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will now be made to the accompanying drawings, which are not necessarily drawn to scale, and wherein:

FIG. 1 shows a block diagram of an apparatus that may be specifically configured in accordance with an example embodiment of the present invention;

FIG. 2 is a flow chart showing an example process used to conveniently capture information regarding a multi-frame set of images in accordance with an example embodiment of the present invention;

FIG. 3 is a flow chart describing an example process that may additionally capture user-intended post-processing actions with respect to the set of images in accordance with an example embodiment of the present invention;

FIG. 4 shows a data model graphically illustrating example metadata parameters for implementing certain embodiments of the present invention; and

FIGS. 5-10 show example results that can be created by automatic post-processing a set of images annotated using example embodiments of the present invention.

### DETAILED DESCRIPTION

Some embodiments of the present invention will now be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout. As used herein, the terms “data,” “content,” “information,” and similar terms may be used interchangeably to refer to data capable of being transmitted, received, and/or stored in accordance with embodiments of the present invention. Thus, use of any such terms should not be taken to limit the spirit and scope of embodiments of the present invention.

Additionally, as used herein, the term “circuitry” refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, as used herein, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

A method, apparatus, and computer program product are provided in accordance with an example embodiment of the present invention in order to automate the preparation of a set of images for post-processing. As such, the method, apparatus, and computer program product may be embodied by any of a variety of devices that are configured to receive and store digital images. For example, the devices may include any of a variety of mobile terminals, such as a portable digital assistant (PDA), mobile telephone, smartphone, mobile television, gaming device, laptop computer, camera, tablet computer, video recorder, web camera, or any combination of the aforementioned devices. Additionally or alternatively, the computing device may include fixed computing devices, such as a personal computer or a computer workstation. Still further, the method, apparatus, and computer program product of an example embodiment may be embodied by a networked device, such as a server or other network entity, configured to receive images from one or more devices, such as one or more client devices.

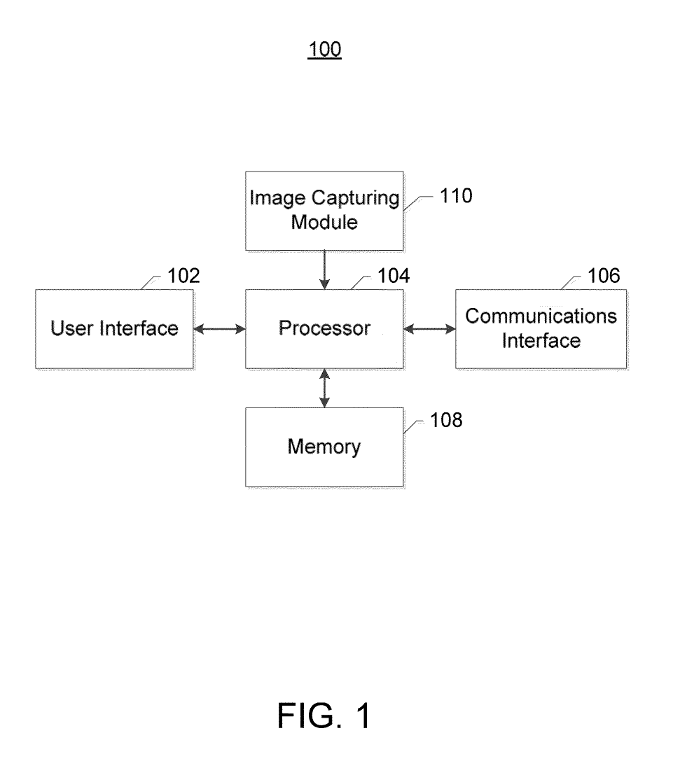

Regardless of the type of device, an apparatus 100 that may be specifically configured to create and store multi-image metadata in conjunction with a set of images in accordance with an example embodiment of the present invention is illustrated in FIG. 1. It should be noted that while FIG. 1 illustrates one example configuration, numerous other configurations may also be used to implement embodiments of the present invention. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

Referring now to FIG. 1, the apparatus 100 may include or otherwise be in communication with a processor 104, a memory device 108, and optionally a communication interface 106, a user interface 102 and/or an image capturing module, such as a camera 110. In some embodiments, the processor (and/or co-processor or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like, for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

The apparatus 100 may be embodied by a computing device, such as a mobile terminal. However, in some embodiments, the apparatus may be embodied as a chip or chip set. In other words, the apparatus may comprise one or more physical packages (e.g., chips) including materials, components, and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 104 may be embodied in a number of different ways. For example, the processor may be embodied as one or more of various hardware processing means such as a co-processor, a microprocessor, a controller, a digital signal processor (DSP), a processing element with or without an accompanying DSP, or various other processing circuitry including integrated circuits such as, for example, an ASIC (application specific integrated circuit), an FPGA ((field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining, and/or multithreading.

In an example embodiment, the processor 104 may be configured to execute instructions stored in the memory device 108 or otherwise accessible to the processor. Alternatively or additionally, the processor may be configured to execute hard-coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA, or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU), and logic gates configured to support operation of the processor.

Meanwhile, the communication interface 106 may be any means such as a device or circuitry embodied in either hardware or a combination of hardware and software that is configured to receive and/or transmit data from/to a network and/or any other device or module in communication with the apparatus 100. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB), or other mechanisms.

In some embodiments, the apparatus 100 may include a user interface 102 that may, in turn, be in communication with processor 104 to provide output to the user and, in some embodiments, to receive an indication of a user input. As such, the user interface may include a display and, in some embodiments, may also include a keyboard, a mouse, a joystick, a touch screen, touch areas, soft keys, a microphone, a speaker, or other input/output mechanisms. Alternatively or additionally, the processor may comprise user interface circuitry configured to control at least some functions of one or more user interface elements such as a display and, in some embodiments, a speaker, ringer, microphone, and/or the like. The processor and/or user interface circuitry comprising the processor may be configured to control one or more functions of one or more user interface elements through computer program instructions (e.g., software and/or firmware) stored on a memory accessible to the processor (e.g., memory device 14, and/or the like).

As shown in FIG. 1, the apparatus 100 may also include an image capturing module 110, such as a camera, video and/or audio module, in communication with the processor 104. The image capturing element may be any means for capturing an image, video and/or audio for storage, display or transmission. As used herein, an image includes a still image as well as an image from a video recording. For example, in an example embodiment in which the image capturing element is a camera, the camera may include a digital camera capable of forming a digital image file from a captured image. As such, the camera may include all hardware (for example, a lens or other optical component(s), image sensor, image signal processor, and/or the like) and software necessary for creating a digital image file from a captured image. Alternatively, the camera may include only the hardware needed to view an image, while the memory 108 of the apparatus stores instructions for execution by the processor in the form of software necessary to create a digital image file from a captured image. In an example embodiment, the camera may further include a processing element such as a co-processor which assists the processor in processing image data and an encoder and/or decoder for compressing and/or decompressing image data. The encoder and/or decoder may encode and/or decode according to, for example, a joint photographic experts group (JPEG) standard, a moving picture experts group (MPEG) standard, or other format.

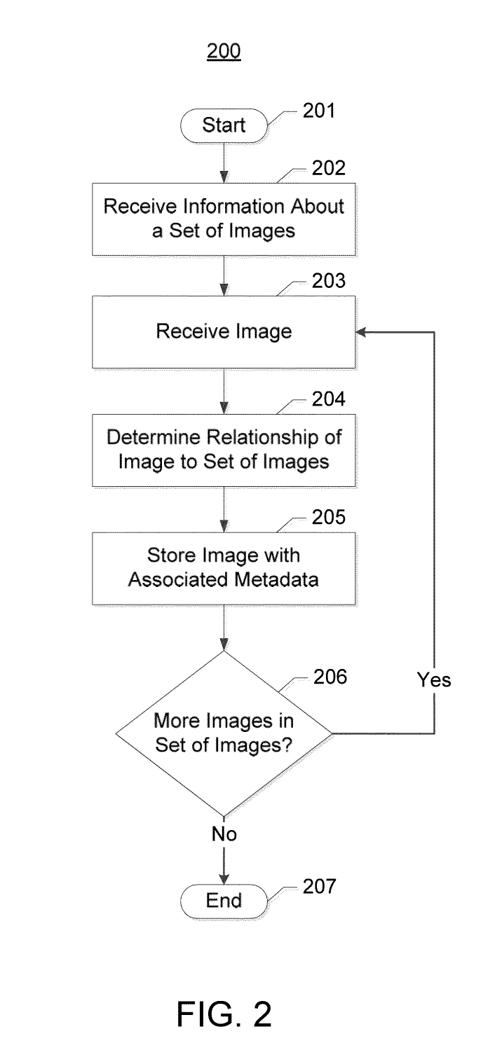

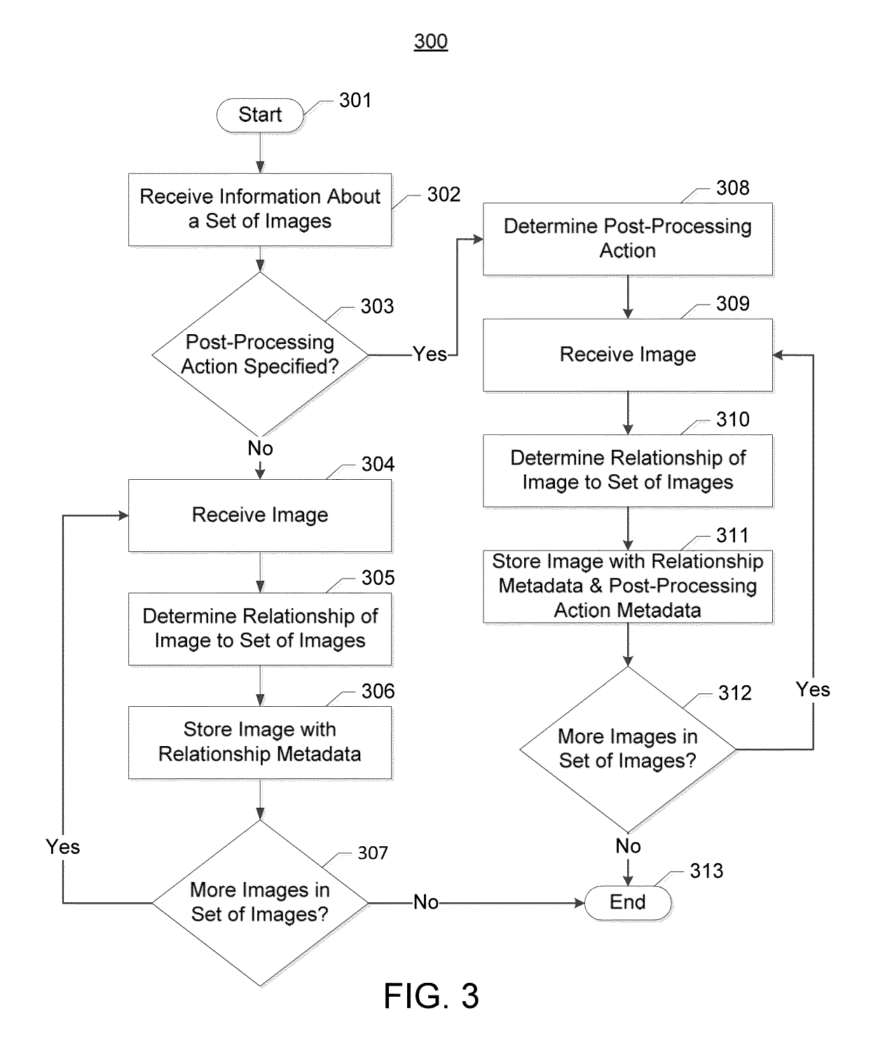

Referring now to FIG. 2, flowchart 200 illustrates operations performed in order to create and store associative metadata in conjunction with a multi-frame set of images. The operations illustrated in FIG. 2 may, for example, be performed by, with the assistance of, and/or under the control of one or more of processor 104, memory 108, user interface 102, or communications interface 106. The process starts at 201 and proceeds to operation 202, in which the apparatus 100 includes means, such as the processor, the communications interface, or the like, for comprises receiving information about a set of images. The received information may include a designation that an image is a member of a set of images. The received information may additionally or alternatively specify an order of the image within the set of images and the total number of images to be included in the set of images. Optionally, the received information may also indicate a desired post-processing action for the set of images, as will be discussed below in connection with FIG. 3. The received information may further include descriptive information about the set of images (such as, for example, title information for the set of images). The received information may be user-submitted, for example via user interface 102 or communications interface 106. Alternatively, the received information may be automatically generated by the apparatus 100, such as the processor 102, from a review of the set of images. The information received in operation 202 may be received at a discrete point in time or may be received throughout the duration of any one or more portions of the process illustrated in FIG. 2.

As shown in operation 203, the apparatus may also include means, such as the processor, the communications interface, or the like, for receiving an image from the set of images. The image may be received from an image sensor, such as a camera, video recorder, or any image capture device, that captures the image. The image sensor may be an element of the apparatus or, alternatively, may be an external device that communicates with the apparatus via, for example, communications interface 106. However, it is not necessary for the image to be captured by an image sensor, and the image may alternatively be created using any of a variety of methods and subsequently received from storage in memory 108, from a user via the user interface 102, or via communications interface 106.

The apparatus may also include means, such as the processor or the like, for determining information regarding the relationship of the image received in operation 202 to the set of images. See operation 204. In one embodiment of this operation, a processor, such as processor 104, may filter the information received in operation 202 to determine information regarding the specific image received in operation 203. For instance, if the information received in operation 202 indicates that there are five images in the set of images, the processor may determine in operation 204 that the set size is five. Additionally or alternatively, the apparatus, such as the processor, may determine the sequence number of the image within the set (e.g., whether the currently received image is the first, second, third, fourth, or fifth, in this example) during operation 203. If the information received in operation 202 does not include a sequence number for the received image, however, then the sequence information may be automatically determined by the apparatus, such as the processor, using a counter that increments for each image that is received, or alternatively may be automatically added by the apparatus, such as the processor, to each image upon completion of the process illustrated in FIG. 2. In either case, the information regarding the relationship of the image to the set of images may also include data indicating that the specific image is part of the set of images. The information may also comprise one or more image parameters specific to the image that might change between images in the set, such as the f-number, focal length, film speed (ISO), exposure time, and direction.

Pursuant to operation 205, the apparatus may include means, such as the processor, memory, or the like, for causing information regarding the specific image (determined in operation 204) to be stored as metadata associated with the specific image. For example, new metadata properties may be added to either Exif (Exchangeable Image File Format) or XMP (Adobe™ Extensible Media Platform, ISO 16684-1:2012) metadata associated with the image. In one embodiment, the new metadata properties may be added to XMP metadata, because this alteration would not require a new Image File Directory (IFD) or a change to the basic standard specification. These metadata properties may include the information regarding the specific image determined in operation 204, such as a parameter specifying that the image is a part of the set of images, a parameter specifying a sequence number of the image within the set of images, and/or a parameter indicating the total number of images in the set of images. However, these parameters are examples only, and additional or alternative metadata properties may be added to the metadata associated with the image based on the information determined in operation 204.

In operation 206, the apparatus may include means, such as the processor, or the like, for determining whether the received image is the final image in the set of images. For example, if the apparatus, such as the processor, determined in operation 204 that the there are five total images in the set of images, and the last image received was the fifth image, then a processor, such as processor 104, may determine that there are no more images in the set. In this case, the process ends at 207. In contrast, if the last image received was only the third image, for example, then the process returns to operation 203 to receive another image. If, for example, information received in operation 202 does not indicate the total number of images in the set, then operations 203-206 may be repeated until the apparatus, such as the processor, receives an indication that all relevant images have been received, at which point the process ends at 207. Accordingly, flowchart 200 illustrates an example embodiment in which metadata properties are added to identify each image as a sequenced part of a related set of images.

Furthermore, metadata may be added that captures the action(s) to be performed on that sequence in order to realize the creator's intent. For example, the set could be labeled as a High Dynamic Range (HDR) set, in which case it would be clear that the initial intent is to post-process the marked set as an HDR sequence. This would allow for the automation of the post-processing activity. Automation of this activity can be used both by traditional photo editing software, and by software that can process multiple images within the camera for new and unique effects that are not possible when processing a single frame. Since there may be artistic or technical alternatives available to processing, extensible metadata semantics are provided for capturing these choices at shot time.

Referring now to FIG. 3, flowchart 300 illustrates operations performed in order to add metadata that enable automation of the post-processing activity. The process starts at 301 and proceeds to operation 302. As shown in operation 302, the apparatus may include means, such as the processor, the communications interface, or the like, for receiving information about a set of images, and is similar to operation 202, described above. In addition, the information received about the set of images may also include information regarding post-processing actions to be taken with respect to the set of images.

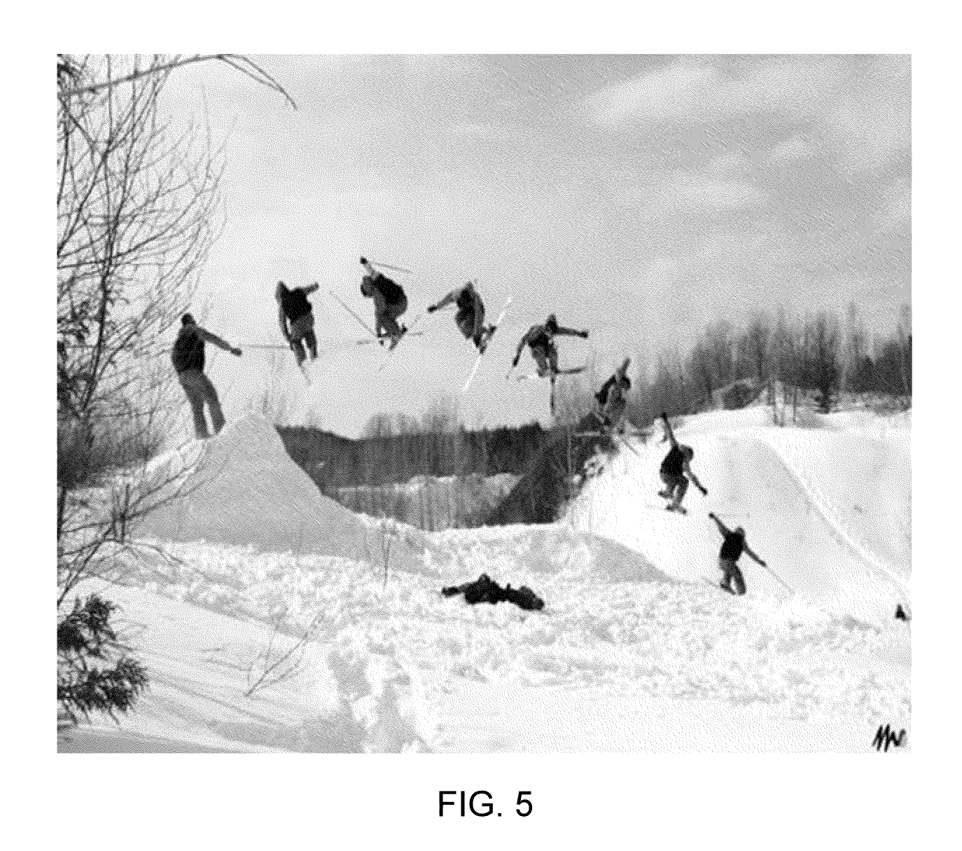

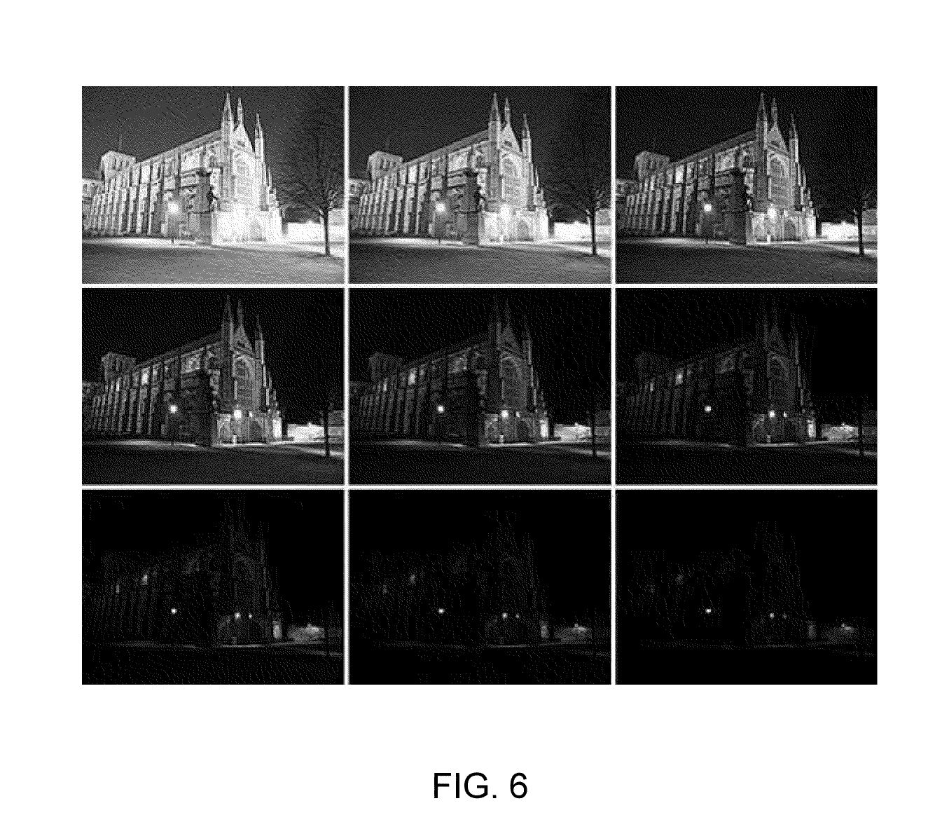

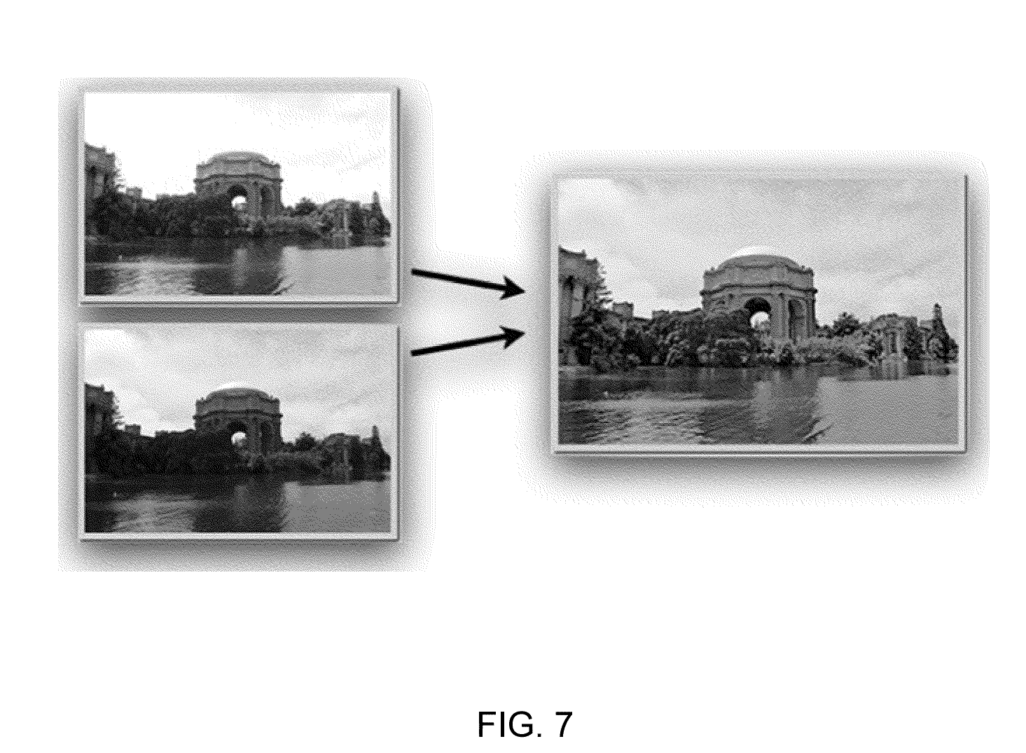

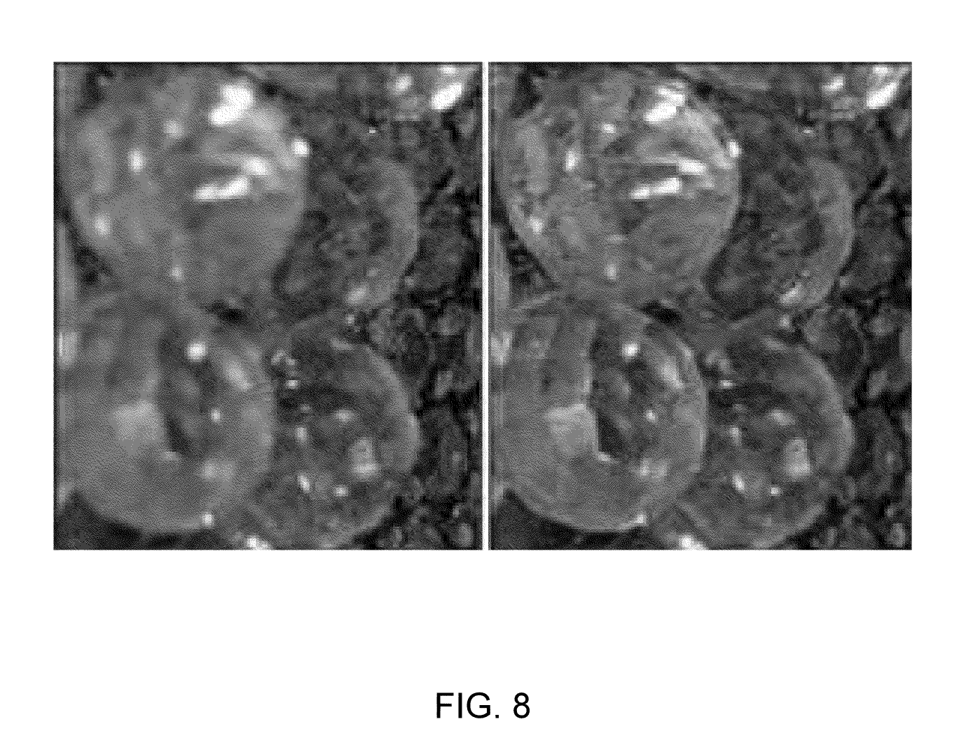

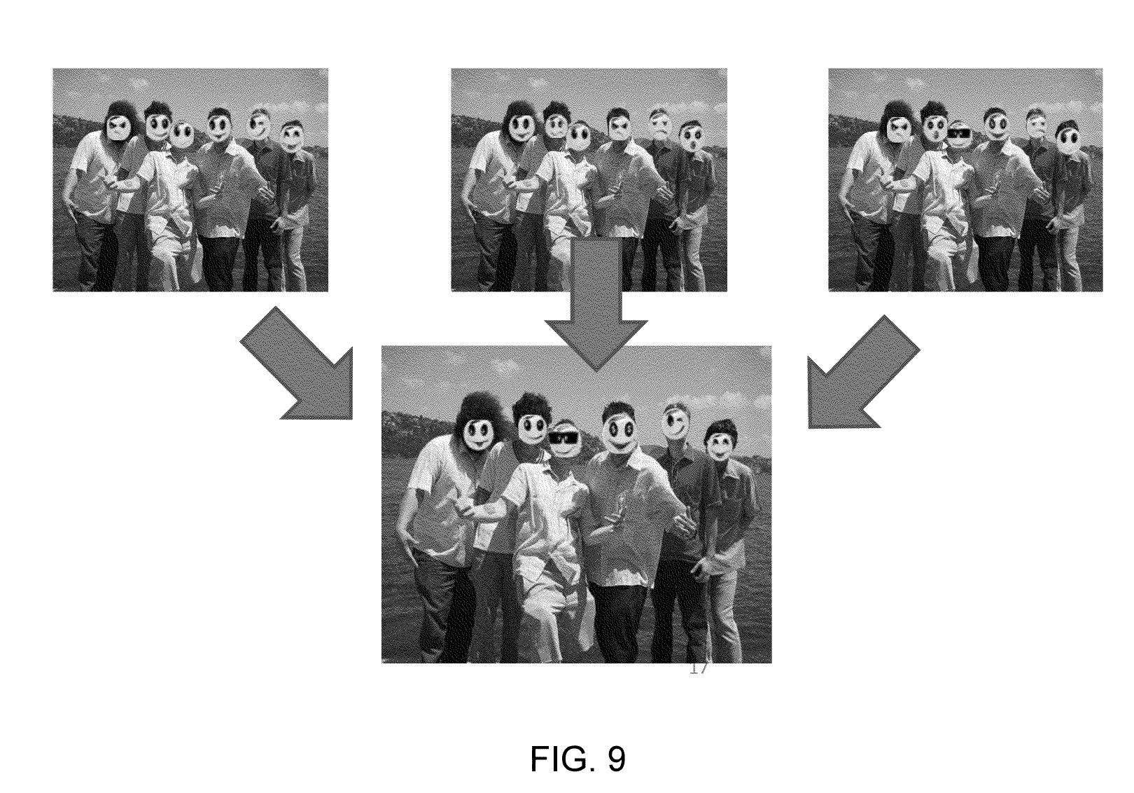

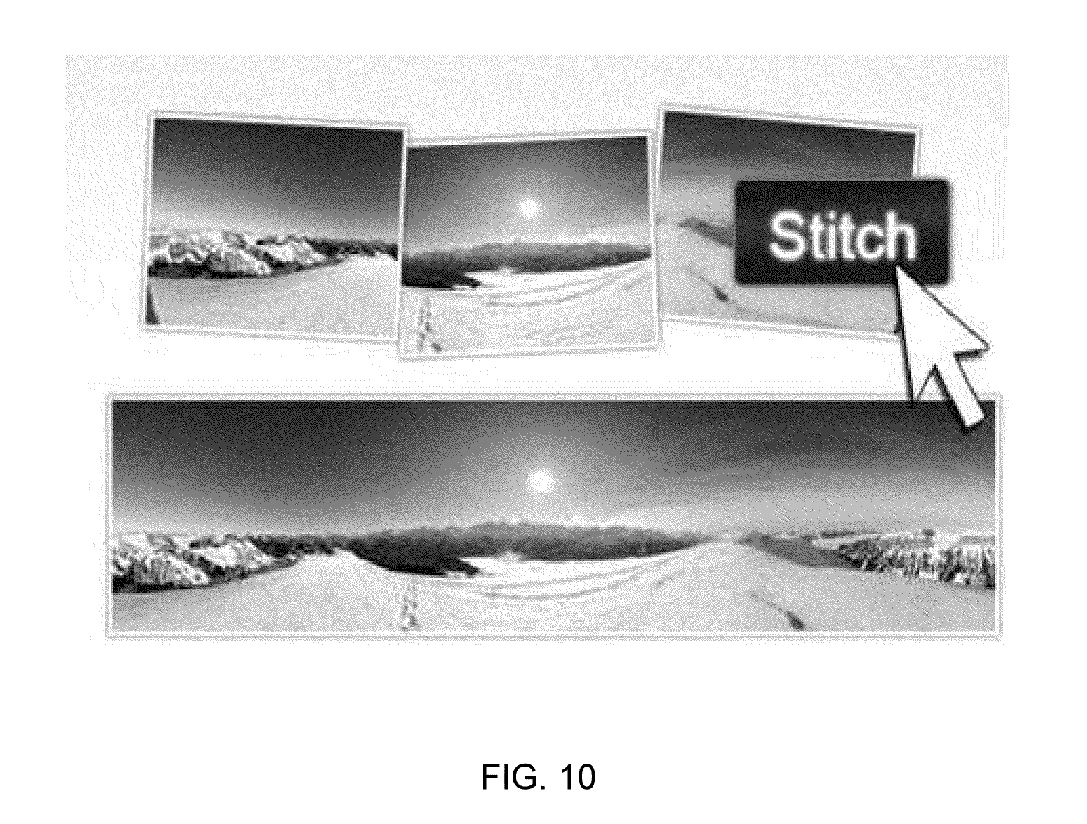

FIGS. 5-10 show example post-processing actions that may be performed by the apparatus, such as the processor, by executing, for example, post-processing software. For instance, FIG. 5 shows a sequence image created using burst mode photography, in which features from a sequence of images captured in quick succession have been combined together to show motion within a still image. Using a similar process, an animation effect can be produced by collapsing the images into an image sequence which highlights the changes from one frame to the next. FIG. 6 shows several images created using bracketing, in which images are captured in quick succession and with a variety of image-capturing parameters. FIG. 7 shows a still image created using high dynamic range photography, in which multiple images are taken using different exposure lengths, and are thereafter combined using post-processing software to create a still image with greater contrast. FIG. 8 shows an image created using focus stacking, in which multiple images are taken with different focus distances, and then combined into an image that has far greater depth of field. FIG. 9 shows a process whereby parts of multiple original images of a group of people are combined in a post-process to create a result in which every person in the field of view is smiling. FIG. 10 shows a panorama post-processing operation, in which multiple original images are stitched together to create a panoramic image. However, these post-processing actions are examples only, and additional or alternative post-processing actions may be performed by the apparatus.

Referring back to operation 302 of FIG. 3, the apparatus, such as the processor, the communications interface, or the like, may additionally receive an indication of the user's intended post-processing action, which may comprise, for example, one of the actions described above with respect to FIGS. 5-10. This information may optionally include specific actions to be performed on all of the images of the set of images and specific actions to be performed on specific images in the set.

Pursuant to operation 303, the apparatus may include means, such as the processor or the like, for determining whether any post-processing actions are included in the information received in operation 302. If not, then the process continues to operation 304.

In accordance with operation 304, the apparatus may include means, such as the processor, the communications interface, or the like, for receiving an image from the set of images. The image may be received from an image sensor (e.g., camera 110) that captures the image. The image sensor may be an element of the apparatus or, alternatively, may be an external device that communicates with the apparatus via, for example, communications interface 106. However, it is not necessary for the image to be captured by an image sensor, and the image may alternatively be created using any of a variety of methods and subsequently received from storage in memory 108, from a user via the user interface 102, or via communications interface 106.

The apparatus may also include means, such as the processor or the like, for determining information regarding the relationship of the image received in operation 304 to the set of images. See operation 305. In this operation a processor, such as processor 104, may filter the information received in operation 302 to determine information regarding the specific image received in operation 304. For instance, if the information received in operation 302 indicates that there are five images in the set of images, it may be determined in operation 305 that the set size is five. Additionally or alternatively, the apparatus, such as the processor, may determine the sequence number of the image within the set (e.g., whether the currently received image is the first, second, third, fourth, or fifth, in this example). If the information received in operation 302 does not include a sequence number for the received image, however, then the sequence information may be automatically determined using a counter that increments for each image that is received, or alternatively may be automatically added to each image upon completion of the process illustrated in FIG. 3. In either case, the information regarding the relationship of the image to the set of images may also include data indicating that the specific image is part of the set of images. The information may also comprise one or more image parameters specific to the image that might change between images in the set, such as the f-number, focal length, film speed (ISO), exposure time, and direction.

In accordance with operation 306, the apparatus may include means, such as the processor, the memory, or the like, for causing the information regarding the specific image (determined in operation 305) to be stored as metadata associated with the specific image, such as by adding new metadata properties to either Exif or XMP metadata associated with the image. As with operation 205, in one embodiment of operation 306, the new metadata properties may be added to XMP metadata, because this alteration would not require a new IFD or a change to the basic standard specification. These metadata properties may include the information regarding the specific image determined in operation 305, such as a parameter specifying that the image is a part of the set of images, or a parameter specifying a sequence number of the image within the set of images, or a parameter indicating the total number of images in the set of images. However, these parameters are examples only, and additional or alternative metadata properties may be added to the metadata associated with the image based on the information determined in operation 305.

Pursuant to operation 307, the apparatus may include means, such as the processor or the like, for determining whether the received image is the final image in the set of images. For example, if the apparatus, such as the processor, in operation 305 determined that there are five total images in the set of images, and the last image received was the fifth image, then a processor, such as processor 104, may determine that there are no more images in the set. In this case, the process ends at 313. In contrast, if the last image received was only the third image, for example, then the process returns to operation 304 to receive another image. If, for example, information received in operation 304 only includes selection of a multi-image mode, then operations 304-307 will repeat until the apparatus, such as the processor, the communications interface, or the like, receives an indication that all relevant images have been received, at which point the process ends at 313.

Returning to operation 303, if the apparatus, such as the processor, determines that post-processing actions are included in the information received in operation 302, the process instead continues from operation 303 to operation 308.

In this regard, the apparatus may include means, such as the processor, or the like, for determining the post-processing action to be performed on the set of images. See operation 308. In this operation, the apparatus, such as a processor (e.g., processor 104) may filter the information about the set of images to extract only information regarding post-processing the set of images. For instance, if the information received in operation 308 indicates that the set of images are intended to be combined into a panorama image, this information will be extracted. Of course, the post-processing action may include several discrete operations. For instance, for any given post-processing action identified for the set of images, there may be additional Global Action Parameters that apply to every image in the set. In operation 308, any such Global Action Parameters are identified.

In accordance with operation 309, the apparatus may include means, such as the processor, the communications interface, or the like, for thereafter receiving an image from the set of images. As with operations 203 and 304, the image may be generated using any of a variety of methods and subsequently received from storage in memory 108, from a user via the user interface 102, or via communications interface 106.

The apparatus of this embodiment may also include means, such as the processor or the like, for determining information regarding the relationship of the image received in operation 309 to the set of images. In this operation, the apparatus, such as a processor (e.g., processor 104) may filter the information received in operation 302 to determine information regarding the specific image received in operation 309. For instance, if the information received in operation 302 indicates that there are five images in the set of images, it may be determined in operation 310 that the set size is five. Additionally or alternatively, the apparatus, such as the processor, may determine in operation 310 the sequence number of the image within the set (e.g., whether the currently received image is the first, second, third, fourth, or fifth, in this example). If the information received in operation 302 does not include a sequence number for the received image, however, then the sequence information may be automatically determined by the apparatus, such as the processor, using a counter that increments for each image that is received, or alternatively the apparatus, such as the processor, may automatically add the sequence number to each image upon completion of the process illustrated in FIG. 3. In either case, the information regarding the relationship of the image to the set of images may also include data indicating that the specific image is part of the set of images. The information may also comprise one or more image parameters specific to the image that might change between images in the set, such as the f-number, focal length, film speed (ISO), exposure time, and direction. Additionally, the apparatus, such as the processor, may identify in operation 310 Image Specific Action Parameters that will apply only to the specific image received in operation 309.

In operation 311, the apparatus may include means, such as the processor, the memory, or the like, for causing information regarding the specific image (determined in operation 305) to be stored as metadata associated with the specific image by adding new metadata properties to either Exif or XMP metadata associated with the image. As with operations 205 and 306, in one embodiment of operation 311 the new metadata properties may be added to XMP metadata, because this alteration would not require a new IFD or a change to the basic standard specification. These metadata properties may include the information regarding the specific image determined in operation 310, such as a parameter specifying that the image is a part of the set of images, or a parameter specifying a sequence number of the image within the set of images, or a parameter indicating the total number of images in the set of images. In addition, the metadata properties may include information regarding the action to be performed. For instance, this information could include an identification of the intended action and an identification of any Global Action Parameters that are identified in operation 308, and an identification of any Image Specific Action Parameters identified in operation 310. However, these parameters are examples only, and additional or alternative metadata properties may be added to the metadata associated with the image based on the information determined in operation 310.

In operation 312, the apparatus may include means, such as the processor, or the like, for determining whether the received image is the final image in the set of images. For example, if the apparatus, such as the processor, determined in operation 310 that the there are five total images in the set of images, and the last image received was the fifth image, then the apparatus, such as a processor (e.g., processor 104) may determine that there are no more images in the set. In this case, the process ends at 313. In contrast, if the last image received is only the third image, for example, then the process returns to operation 309 to receive another image. If, for example, information received in operation 302 does not indicate the total number of images in the set, then the apparatus, such as the processor, may cause operations 304-307 to repeat until the apparatus receives an indication that all relevant images have been received, at which point the process ends at 313.

By inserting the necessary metadata into the set of images, such as using the example process illustrated in FIG. 3, the method, apparatus, and computer program product may allow for the explicit automation of the post-processing of multi-frame image sets without intervention. Accordingly, the user will be freed from or subjected to a reduced burden with respect to manual image manipulation. Alternatively, according to the process described above in connection with FIG. 2, the method, apparatus, and compute program product may generalize the management and use of multi-image sets without tying the identification of a set of images to any particular set of actions.

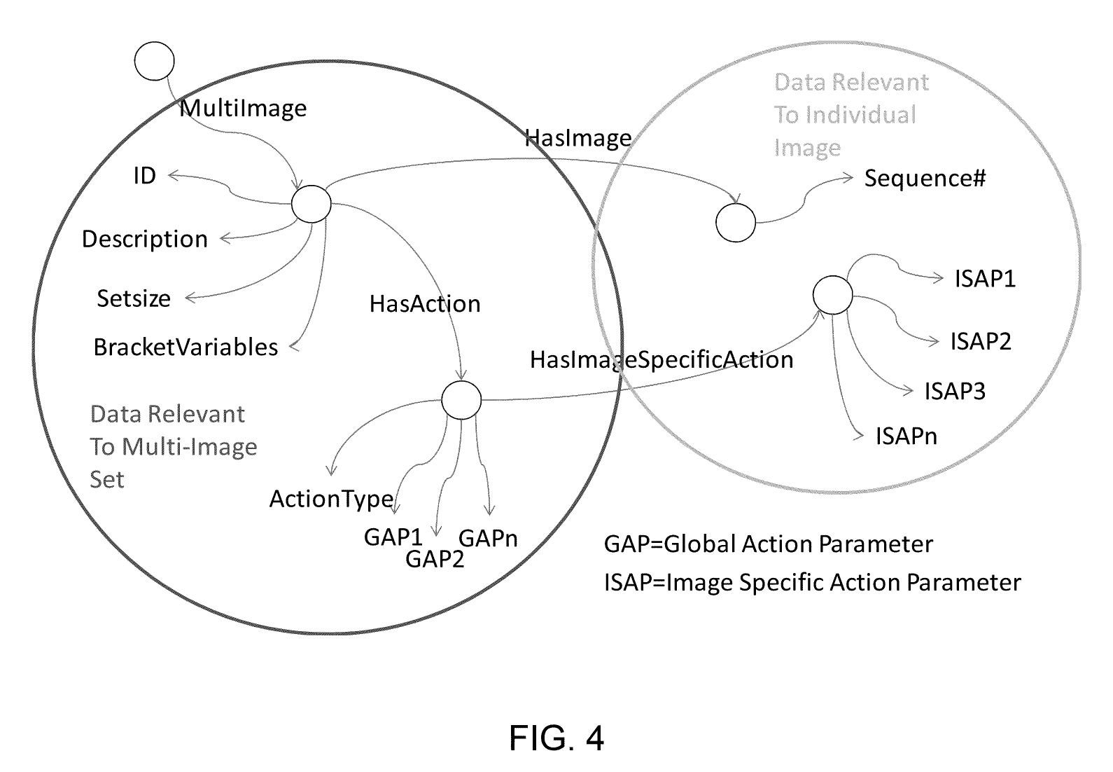

FIG. 4 shows an example Resource Description Framework (RDF) data model that may be used to implement an example embodiment of the present invention. In the data model, the parameters in the left circle relate to every image in the set of image, while the parameters in the right circle are image-specific. All of the parameters may be stored in the metadata associated with an image in a set of images. Of course, any number of alternative data models may be used to implement other embodiments of the present invention.

There is an existing standard for the packaging of multiple still image frames into a single file that contains all related frames. The standard is “Multi-Picture Format-CIPA DC-007, 2009,” otherwise known as “.mpo” file format. It describes both a file format and some metadata related to multi-images, and is discussed in U.S. Patent Application Publication No. 2011/0279690, titled “ELECTRONIC DEVICE, CAMERA AND COMPUTER PROGRAM PRODUCT OF IMAGE PROCESSING” and published on Nov. 17, 2011.

The .mpo file format has not been widely accepted in the marketplace, however, because of a fundamental lack of backwards compatibility. If an .mpo ignorant application attempts to process an .mpo file (as, say, a .jpeg), then the application can, at best, see only the first image in the set of images. Subsequent frames may be inaccessible. Furthermore, the .mpo format creates a new IFD for containing the multi-image metadata in Exif format, which requires new software to recognize the new metadata properties, and also requires a new extended data format.

Accordingly, the method, apparatus, and computer program product of an example embodiment of the present invention may provide a multi-frame mechanism with maximal backwards compatibility. In other words, old or multi-frame “ignorant” applications may still be able to at least process images as well as they can today. Unlike the .mpo file format, the method, apparatus, and computer program product of an example embodiment does not require the creation, and hence understanding of, a new data format. Thus, downstream applications that do not understand these extensions can still process images. Accordingly, the method, apparatus, and computer program product of an example embodiment of the present invention may avoid the problem encountered when using the CIPA standard, which defines a new format and causes ignorant applications to be unable to recover any but the first image in the .mpo file.

As described above, FIGS. 2 and 3 illustrate flowcharts of the operation of an apparatus, method, and computer program product according to example embodiments of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 108 of an apparatus employing an embodiment of the present invention and executed by a processor 104 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which preform the specified functions, or combinations of special purpose hardware and computer instructions.

In some embodiments, certain ones of the operations above may be modified or further amplified. Furthermore, in some embodiments, additional optional operations may be included. Modifications, amplifications, or additions to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving information about a set of images;
receiving an image from the set of images;
determining, by a processor, information about a relationship of the image to the set of images; and
causing storage of the image in conjunction with metadata about the image, the metadata including the information about the relationship of the image to the set of images.

2. The method of claim 1, wherein the information about the relationship of the image to the set of images comprises at least one of:
a parameter specifying that the image is part of the set of images; or
a parameter specifying a sequence number of the image within the set of images.

3. The method of claim 2, wherein the information about the relationship of the image to the set of images further comprises a parameter describing the set of images.

4. The method of claim 1, further comprising:
determining a parameter specifying a post-processing action to be performed on the set of images,
wherein the metadata includes the parameter specifying the post-processing action to be performed on the set of images.

5. The method of claim 4, further comprising:
determining a parameter describing a characteristic specific to the individual image,
wherein the metadata includes the parameter describing a characteristic specific to the individual image.

6. The method of claim 1, wherein the information about the set of images includes information about image variables that will change between images.

7. The method of claim 1, further comprising:
determining a number of images in the set of images,
wherein receiving an image, determining information about a relationship of the image to the set of images, and causing storage of the image are repeated until the determined number of images have been stored in conjunction with respective metadata, and
wherein the information about the relationship of the image to the set of images includes a parameter specifying the number of images in the set of images.

8. An apparatus comprising at least one processor and at least one memory including computer program code, the at least one memory and the computer program code configured to, with the one processor, cause the apparatus to:
receive information about a set of images;
receive an image from the set of images;
determine information about a relationship of the image to the set of images; and
cause the image to be stored in conjunction with metadata about the image, the metadata including the information about the relationship of the image to the set of images.

9. The apparatus of claim 8, wherein the information about the relationship of the image to the set of images comprises at least one of:
a parameter specifying that the image is part of the set of images; or
a parameter specifying a sequence number of the image within the set of images.

10. The apparatus of claim 9, wherein the information about the relationship of the image to the set of images further comprises a parameter describing the set of images.

11. The apparatus of claim 8, wherein the at least one memory and the computer program code are further configured to, with the one processor, cause the apparatus to at least:
determine a parameter specifying a post-processing action to be performed on the set of images,
wherein the metadata includes the parameter specifying the post-processing action to be performed on the set of images.

12. The apparatus of claim 11, wherein the at least one memory and the computer program code are further configured to, with the one processor, cause the apparatus to at least:
determine a parameter describing a characteristic specific to the individual image,
wherein the metadata includes the parameter describing the characteristic specific to the individual image.

13. The apparatus of claim 8, wherein the information about the set of images includes information about image variables that will change between images.

14. The apparatus of claim 8, wherein the at least one memory and the computer program code are further configured to, with the one processor, cause the apparatus to at least:
determine a number of images in the set of images; and
repeat receiving an image, determining information about a relationship of the image to the set of images, and storing the image until the determined number of images have been stored in conjunction with respective metadata,
wherein the information about the relationship of the image to the set of images includes a parameter specifying the number of images in the set of images.

15. A computer program product comprising at least one non-transitory computer-readable storage medium having computer-executable program code portions stored therein, the computer-executable program code portions comprising program code instructions that, when executed, cause an apparatus to:
receive information about a set of images;
receive an image from the set of images;
determine information about a relationship of the image to the set of images; and
cause the image to be stored in conjunction with metadata about the image, the metadata including the information about the relationship of the image to the set of images.

16. The computer program product of claim 15, wherein the information about the relationship of the image to the set of images comprises at least one of:
a parameter specifying that the image is part of the set of images; or
a parameter specifying a sequence number of the image within the set of images.

17. The computer program product of claim 16, wherein the information about the relationship of the image to the set of images further comprises a parameter describing the set of images.

18. The computer program product of claim 15, wherein the computer-executable program code portions further comprise program code instructions that, when executed, cause the apparatus to:
determine a parameter specifying a post-processing action to be performed on the set of images,
wherein the metadata includes the parameter specifying the post-processing action to be performed on the set of images.

19. The computer program product of claim 18, wherein the computer-executable program code portions further comprise program code instructions that, when executed, cause the apparatus to:
determine a parameter describing a characteristic specific to the individual image,
wherein the metadata includes the parameter describing the characteristic specific to the individual image.

20. The computer program product of claim 15, wherein the information about the set of images includes information about image variables that will change between images.

21. The computer program product of claim 15, wherein the computer-executable program code portions further comprise program code instructions that, when executed, cause the apparatus to:
determine a number of images in the set of images; and
repeat receiving an image, determining information about a relationship of the image to the set of images, and storing the image until the determined number of images have been stored in conjunction with respective metadata,
wherein the information about the relationship of the image to the set of images includes a parameter specifying the number of images in the set of images.
